(19) United States
(12) Patent Application Publication
(10) Pub. No.: US 2012/0148473 A1
(43) Pub. Date: Jun. 14, 2012

(54) METHOD OF MAKING CARBIDE DERIVED CARBON WITH ENHANCED POROSITY AND HIGHER PURITY

(75) Inventor: Oleksandr Kramarenko, Bristol, PA (US)

(73) Assignee: Y-CARBON, INC., Bristol, PA (US)

(21) Appl. No.: 13/316,715

(22) Filed: Dec. 12, 2011

Related U.S. Application Data
(60) Provisional application No. 61/422,880, filed on Dec. 14, 2010.

(51) Int. Cl. B01J 20/30; C01B 31/00; C01B 31/02

(52) U.S. Cl. 423/445 R; 502/418

(57) ABSTRACT

Purity (chemical composition) and porosity of carbons are important for most of their applications. There are several methods of making porous carbons. Carbide derived carbon represents a method of manufacturing carbon from metal carbides by thermochemical etching of metals and/or metalloids at elevated temperatures. This invention provides a method of manufacturing carbide derived carbon with higher purity. The produced carbons can be used in several applications where higher purity carbons are desired including but not limited to gas chromatography, liquid chromatography, supercapacitors, batteries, fuel cells, hemodiafiltration, enterosorbent, and toxin removal from biological fluids.

### FIELD OF INVENTION

The present invention relates to a method of making high purity porous carbon by halogenation of carbides at elevated temperatures.

### BACKGROUND OF THE INVENTION

Carbide derived carbons (CDCs) are carbons prepared by thermo-chemical etching of metal(s) from metal carbides in a halogen environment (Gogotsi et al, Nature Materials, 2003, Dash, Ph.D. thesis, Drexel University, 2006, Dash et al, Carbon, 2006, Dash et al, Microporous and Mesoporous Materials, 2004, Dash et al, Microporous and Mesoporous Materials, 2005, Yushin et al, Nanomaterials Handbook, 2006). The general reaction involved in synthesis of carbon from metal carbides can be written as: MₐC_{b(s)}+(c/2)Cl_{2(g)}→aMClc(g)+bC₍ₛ₎, where M represents a metal. As metal(s) are removed selectively without loss of carbon atoms and their displacement, which can be controlled by the process temperature, this innovative technology allows production of nanoporous carbon of uniform and controlled pore size (Gogotsi et al, Nature Materials, 2003, Dash, Ph.D. thesis, Drexel University, 2006, Dash et al, Carbon, 2006, Dash et al, Microporous and Mesoporous Materials, 2004, Dash et al, Microporous and Mesoporous Materials, 2005, Yushin et al, Nanomaterials Handbook, 2006). By varying different precursor and processing parameters, pore size can be tuned between 0.5 and 2.2 nanometer with sub-Angstrom (a ten billionth of a meter) precision, something that is unattainable with conventional carbon synthesis (Gogotsi et al, Nature Materials, 2003, Dash, Ph.D. thesis, Drexel University, 2006, Dash et al, Carbon, 2006, Dash et al, Microporous and Mesoporous Materials, 2004, Dash et al, Microporous and Mesoporous Materials, 2005, Yushin et al, Nanomaterials Handbook, 2006). Pores up to 30 nm wide can be prepared using carbides such as Ti₂AlC with a layered structure with accuracy higher than 1 nm.

CDC technology enables fine-tuning of the pore size for specific applications. It has been shown that tuning the pore size allows increase in the capacitance (ion storage capability) when used as electrode material in supercapacitors (Chmiola et al, Science, 2010, Chmiola et al, Science, 2006) or capacitive desalination. Similarly, it has been shown that the gas storage capability (Gogotsi et al, J. Am. Chem. Soc., 2005) of these carbons was superior to any competing material because the size of pores exactly fits the size of gas molecule. It was also shown that by fine tuning the pore size to the size of protein molecules, one was able to increase the adsorption of cytokines (proteins that are elevated in sepsis) by a factor of ten as compared to commercially available activated carbon (AC) currently used in hemofilters (devices used for removing inflammatory cytokines from blood) (Yushin et al, Biomaterials, 2006).

The relation between pore size and performance of CDC for use in supercapacitors and gas storage reveals that the CDCs made at low temperatures (400 to 600° C.) has the highest contribution per specific surface area (Chmiola et al, Science, 2006, Gogotsi et al, J. Am. Chem. Soc., 2005). However, because of low surface area of CDC synthesized at these temperatures, these materials do not show high performance in absolute terms.

The pore size of CDCs increases with chlorination temperature (Dash, Ph.D. thesis, Drexel University, 2006). Also, widening of pores takes place with increase in chlorination temperature. It is also shown that the CDC synthesized at lower temperatures has higher chlorine and metal content (Dash, Ph.D. thesis, Drexel University, 2006).

It has been recognized that the purity of CDC can be improved by undergoing selected post-treatments. For instance, Maletin et al (U.S. Pat. No. 6,697,249, 2004) identified high-temperature post-treatment in argon followed by annealing in hydrogen as a method to remove retained chlorine and metal chlorides in CDC.

Furthermore, the porosity of CDC can be improved by activation, in which existing pores are widened and new ones are created by the use of an oxidizing agent. Leis et al (US 2006/0140846) described the enhancement of carbon porosity by heating CDC materials saturated with water under an inert atmosphere. Portet et al (Phys. Chem. Chem. Phys., 2009) noted that energy density of CDC based electrode for use in supercapacitor can be increased significantly on a gravimetric basis following activation with KOH. Leis et al (U.S. Pat. No. 7,803,345) noted that the chlorination of titanium oxide together with titanium carbide could result in the in situ activation of the CDC formed by the chlorination of titanium carbide; the chlorinated titanium oxide yielded titanium tetrachloride, which was removed from the reactor and oxygen, which etched the porous carbon formed by chlorination.

For several applications, it is important that the purity of CDC to be improved and the present invention addresses this.

### OBJECTS OF THE INVENTION

It is therefore, the principal object of the present invention to develop a method for manufacturing carbide-derived carbon of higher purity without sacrificing tunabilty of porosity (pore size, pore volume and surface area).

### SUMMARY OF THE INVENTION

This invention relates to a method of manufacturing porous carbon materials prepared by halogenation of metal carbides at elevated temperatures. More particularly, it relates to the use of multiple halogen treatment steps with and without post processing in gaseous environments.

The primary difference between carbide derived carbons produced using the present invention and the prior art lies within the fact that the carbon material produced with this current invention are of higher purity with the possibility of altering the porosity (pore size, surface area and pore volume) further.

### DESCRIPTION OF THE DRAWING

The above and other objects, features and advantages of the present invention will become more apparent from the following description, reference being made of the accompanying drawing in which:

FIG. 1. Weight remain, % and chemical composition of carbon produced from titanium carbide. Weight remain, % is defined as

$$\frac{{w}_{f}}{{w}_{i}} \times 100 ,$$

where w^{f} is weight of carbon produced and wⁱ is weight of metal carbide used for making carbon. Sample 1 was chlorinated at 400° C. for 6 hours. Sample 2 was obtained by argon treatment of sample 1 at 1050° C. for 4 hours. Sample 3 was obtained by chlorination of sample 1 at 1050° C. for 2 hours followed by argon treatment at 1050° C. for 4 hours. The chemical composition was obtained using Proton Induced X-ray Emission (PIXE) technique.

FIG. 2. Electrochemical cyclability for two-step chlorination (solid markers) of Sample 3, as compared to one-step chlorination (open markers) of Sample 1. Electrochemical cells containing carbon electrodes synthesized using the one and two-step chlorination methods were cycled galvanostatically at 25 mA/cm² in 1.5 M tetratethylammonium tetrafluoroborate in acetonitrile. For the one-step chlorination, chlorination took place at 400° C. for 6 hours followed by argon purge at 1050° C. for four hours. For the two-step chlorination, chlorination took place at 400° C. for 6 hours, and then at 1050° C. for 2 hours. The furnace was heated in argon environment between first and second chlorination step. An argon purge of 4 hours at 1050° C. followed the second step chlorination.

FIG. 3A. Weight remain, % of carbon synthesized from titanium carbide at 400° C. “Single-step” in the plot indicates that the titanium carbide powder was exposed to one chlorination temperature. “Ar-treated” in the plot indicates that the carbon produced from titanium carbide was treated to argon environment at the chlorination temperature for 1 hour. “Two-step (900° C., 0.5 h)” in the plot indicates that the sample was exposed to a second chlorination temperature of 900° C. for 0.5 hour after a first chlorination temperature of 400° C. “Two-step (1050° C., 0.5 h)” in the plot indicates that the sample was exposed to a second chlorination temperature of 1050° C. for 0.5 hour after a first chlorination temperature of 400° C. The sample was not exposed to atmosphere between first and second step chlorination. Dashed line in the plot indicates the theoretical value of weight remain, % for conversion from titanium carbide to carbon. The purity of chlorine and argon are 99.999% and 99.999%, respectively. A heating rate of 10° C./min was used.

FIG. 3B. Weight remain, % of carbon synthesized from titanium carbide at 600° C. “Single-step” in the plot indicates that the titanium carbide powder was exposed to one chlorination temperature. “Ar-treated” in the plot indicates that the carbon produced from titanium carbide was treated to argon environment at the chlorination temperature for 1 hour. “Two-step (900° C., 0.5 h)” in the plot indicates that the sample was exposed to a second chlorination temperature of 900° C. for 0.5 hour after a first chlorination temperature of 600° C. “Two-step (1050° C., 0.5 h)” in the plot indicates that the sample was exposed to a second chlorination temperature of 1050° C. for 0.5 hour after a first chlorination temperature of 600° C. The sample was not exposed to atmosphere between first and second step chlorination. Dashed line in the plot indicates the theoretical value of weight remain, % for conversion from titanium carbide to carbon. The purity of chlorine and argon are 99.999% and 99.999%, respectively. A heating rate of 10° C./min was used.

FIG. 3C. Weight remain, % of carbon synthesized from titanium carbide at 800° C. “Single-step” in the plot indicates that the titanium carbide powder was exposed to one chlorination temperature. “Ar-treated” in the plot indicates that the carbon produced from titanium carbide was treated to argon environment at the chlorination temperature for 1 hour. “Two-step (900° C., 0.5 h)” in the plot indicates that the sample was exposed to a second chlorination temperature of 900° C. for 0.5 hour after a first chlorination temperature of 800° C. “Two-step (1050° C., 0.5 h)” in the plot indicates that the sample was exposed to a second chlorination temperature of 1050° C. for 0.5 hour after a first chlorination temperature of 800° C. The sample was not exposed to atmosphere between first and second step chlorination. Dashed line in the plot indicates the theoretical value of weight remain, % for conversion from titanium carbide to carbon. The purity of chlorine and argon are 99.999% and 99.999%, respectively. A heating rate of 10° C./min was used.

FIG. 3D. Weight remain, % of carbon synthesized from titanium carbide at 400° C., 600° C., 800° C., 1000° C. and 1200° C. All samples were treated at a single chlorination temperature. Dashed line in the plot indicates the theoretical value of weight remain, % for conversion from titanium carbide to carbon. The purity of chlorine and argon are 99.999% and 99.999%, respectively. A heating rate of 10° C./min was used.

FIG. 3E. Weight remain, % of carbon synthesized from silicon carbide at 600° C., 800° C. and 1000° C. All samples were treated at a single chlorination temperature. Dashed line in the plot indicates the theoretical value of weight remain, % for conversion from silicon carbide to carbon. The purity of chlorine and argon are 99.999% and 99.999%, respectively. A heating rate of 10° C./min was used.

FIG. 3F. Weight remain, % after treating graphite powder, nanodiamonds and activated carbon with chlorine at 1150° C. for 3.5 hours. All samples were treated at a single chlorination temperature. The purity of chlorine and argon are 99.999% and 99.999%, respectively. A heating rate of 10° C./min was used.

FIG. 4. Pore size distribution (PSD) of Sample A and Sample B. Sample A was produced using single step chlorination temperature of 600° C. Sample B was produced using two-step chlorination; the first chlorination was done at 600° C. followed by a second step chlorination at 1050° C. for 0.5 hour. The sample was not exposed to atmosphere between the first and second chlorination step. Argon was purged while increasing the temperature from 600° C. to 1050° C. A heating rate of 10° C./min was used. The purity of chlorine and argon are 99.999% and 99.999%, respectively. PSD and pore volume were calculated using the non local density functional theory (NLDFT) method provided by Micromeritics's data reduction software and using argon isotherm obtained at 77 K.

### SPECIFIC DESCRIPTION

Porous carbons with high purity and methods of making said porous carbons are provided. The porous carbons can be used in various applications such as gas storage, electrode material in supercapacitors, desalination, purification of gaseous, air or liquid medium, gas sampling, breath analysis, etc.

Exemplary embodiments of the methods of making porous carbons can use metal carbides powder as precursor materials. Exemplary metal carbides that can be used as precursors include, but are not limited to, SiC, TiC, ZrC, B₄C, TaC, Ti₂AlCl, and Mo₂C. The metal carbide materials can incorporate a single type of metal or metalloid, or they incorporate two or more metals and/or metalloids, allowing the pore sizes, specific surface areas and pore volumes of the porous carbons produced from the metal carbides to be further tuned to desired sizes.

The metal carbides used to produce the porous carbons are typically in powder form but can be produced in the form of monoliths, foams, coatings, fibers, or other form factors.

In embodiments, the metal carbides are exposed to a halogen-containing fluid to extract the metal(s) from the metal carbide. Exemplary halogens that can be contained in the halogen-containing fluids to extract metals from the metal carbides include fluorine, chlorine, bromine and iodine or halides of fluorine, chlorine, bromine and iodine. The halogen can be a gas or a liquid and can be either pure or mixed with a gas such as argon, nitrogen or carbon dioxide. The halogen gases can be single gases (e.g., chlorine), or gas mixtures comprising at least one halogen. For example, the gas mixtures can contain an inert carrier gas such as argon, nitrogen, etc. and one or more halogens.

In embodiments, the metal carbide is placed in a vessel in which the metal carbide is heated to a desired temperature. The vessel can be a tube furnace, fluidized bed furnace, packed bed furnace, rotary kiln reactor, tunnel kiln or the like. The metal carbide can be contained in a quartz boat, graphite boat or the like within the vessel.

After placing the metal carbide in the vessel and prior to the heating, the vessel is purged using a suitable gas that is inert to the metal carbide. The gas can be argon, nitrogen or the like. The purging is performed for an amount of time and at a flow rate effective to remove air from the vessel. Typically, the inert gas can be flowed in the vessel for up to about 1 hour.

In an exemplary embodiment, following the purging, a halogen-containing gas is flowed into the vessel heated to the desired temperature. For example, the vessel can be at a temperature of at about 100° C. to at least about 800° C., such as at least about 100° C., at least about 200° C., at least about 300° C., at least about 400° C., at least about 500° C., at least about 600° C., at least about 700° C. or at least about 800° C.

In embodiments, the metal carbide precursors can be reacted with the halogen-containing gas for an amount of time effective to remove substantially all of the metal(s) contained in the metal carbides. The time period can typically range from about 0.1 hours to at least about 10 hours.

After the metal carbide has been reacted with the halogen-containing gas for the desired time period to substantially remove the metal(s) from the metal carbide(s), the vessel is purged using a suitable gas that is inert to the carbon, such as argon, or the like. The purging is performed for an amount of time and at a flow rate effective to remove the halogen-containing gas from the vessel. Typically, the inert gas can be flowed in the vessel for about 3 hours.

After the purging, the porous carbon can undergo an option step of treating in halogen-removing agent. The porous carbon material in the vessel is contacted with a halogen-removing agent that is flowed into the vessel at a temperature and for an amount of time effective to remove substantially all halogen from the carbon and produce substantially pure carbon. The halogen-removing agent can be a hydrogen-containing gas, such as hydrogen, ammonia, or the like. The flowing of the halogen-removing agent can be performed at a temperature of at least about 200° C., at least about 400° C., at least about 600° C., at least about 800° C., or at least about 1000° C. In embodiments, the porous carbons can be exposed to the halogen-removing agent for about 1 hour to at least about 10 hours.

The resultant carbon contains metal chlorides and chlorine as impurities. The resultant carbon is then exposed to a halogen-containing gas to subject it to further etching carbon and to remove metal(s) and chlorine from the resultant carbon. Exemplary halogens that can be contained in the halogen containing include fluorine, chlorine, bromine and iodine or halides of fluorine, chlorine, bromine and iodine. The halogen can be a gas or a liquid and can be in presence of argon, nitrogen or carbon dioxide. The halogen used can be a single gases (e.g., chlorine), or a gas mixture containing at least one halogen. For example, the gas mixtures can contain an inert carrier gas such as argon, nitrogen, etc and one or more halogens. The inert carrier gas can be a noble gas, for example argon. The vessel for the second chlorination step can be a tube furnace, fluidized bed furnace, packed bed furnace, rotary kiln reactor, tunnel kiln, or the like. The carbon can be contained in a quartz boat, graphite boat or the like, inside of the vessel. The second step chlorination can be any temperatures between 900 to 1200° C. For example, the vessel can be at a temperature of at about 900° C. to at least about 950° C., such as at least about 1000° C., at least about 1100° C., at least about 1150° C., or at least about 1200° C. The time for the second step halogenation can be anywhere between 1 minute to 3 hours. The vessel is purged using a suitable gas that is inert to the carbon, such as argon or the like. The purging is performed for an amount of time and at a flow rate effective to remove the halogen-containing gas from the vessel. Typically, the inert gas can be flowed in the vessel for up to 3 hours. After the purging, the porous carbon can undergo an optional treatment with a halogen-removing agent. The porous carbon material in the vessel is contacted with a gaseous halogen-removing agent that is flowed into the vessel at a temperature and for an amount of time effective to substantially remove all halogen from the carbon, producing substantially pure carbon. The halogen-removing agent can be a hydrogen-containing gas, such as hydrogen, ammonia, or the like. The halogen removal treatment can be performed at a temperature of at least about 200° C., at least about 400° C., at least about 600° C., at least about 800° C., or at least about 1000° C. In embodiments, the porous carbons can be exposed to the halogen-removing agent for about 1 hour to at least about 10 hours.

The porous carbons resulting from the halogen-removing treatment following the primary and secondary halogenations of metal carbides have desirable pore structures and compositions. These materials have different porosity and are much pure than those produced using a single chlorination step.

The porous carbons produced by the methods can be used in various applications. These include but are not limited to, air sampling, gas sampling, and breath analysis. The air sampling, gas sampling, breath analysis can be done at or below ground level, or at elevated locations.

The porous carbons can also be used for storing gases. For example, the porous carbons can be used to store hydrogen, methane, carbon dioxide, gases used in semiconductor device manufacturing, and the like.

Furthermore, the porous carbons can be used as electrodes materials for storing energy in supercapacitors (also commonly referred to as ultracapacitors or double layer capacitors) with a greater energy density than conventional activated carbons.

In embodiments, the porous carbons can be used to remove targeted gases from non-moving fluids, as well as moving fluids, by the contacting the porous carbons with the fluids. For example, the targeted gases can be harmful or toxic gases. The gases can also be gases that are desired to be removed for subsequent use.

### EXAMPLES

### Example 1

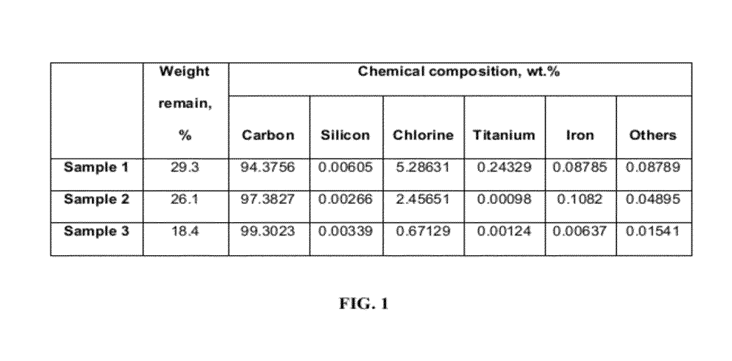

Three CDC samples (Sample 1, 2 and 3) (FIG. 1) were produced by chlorinating titanium carbide (TiC) powder precursor of particle size of <5 μm.

Sample 1 was produced by chlorination at 400° C. for 6 hours followed by argon purge at 400° C. for 30 minutes. The sample was cooled to room temperature under argon purge.

Sample 2 was produced by treating titanium carbide powder at 400° C. for 6 hours in chlorine followed by argon treatment at 1050° C. for 4 hours. The sample was cooled to room temperature under argon purge.

Sample 3 was produced by two-step chlorination. The conditions for first and second step chlorination were 400° C. for 6 hours, and 1050° C. for 2 hours, respectively. The furnace was heated in argon environment between first and second chlorination step. An argon purge of 4 hours at 1050° C. followed the second step chlorination.

Sample 1, Sample 2 and Sample 3 were prepared using the same experimental setup and the cooling and heating rate were same. A heating rate of 10° C./min was used.

The chemical composition of Sample 1, Sample 2 and Sample 3 were determined using Proton Induced X-ray Emission (PIXE) technique. PIXE is an X-ray spectrographic technique, which can be used for the non-destructive, simultaneous elemental analysis of solid, liquid or aerosol filter samples. The X-ray spectrum is initiated by energetic protons exciting the inner shell electrons in the target atoms. The expulsion of these inner shell electrons results in the production of X-rays. The energies of the X-rays, which are emitted when the created vacancies are filled again, are uniquely characteristic of the elements from which they originate and the number of X-rays emitted is proportional to the mass of that corresponding element in the sample being analyzed. Compared to electron based x-ray analytical techniques such as energy dispersive spectroscopy (EDS), PIXE offers better peak to noise ratios and consequently much higher element sensitivities.

As can be seen from FIG. 1, it is clear that Sample 3, which was subjected to second step chlorination has lower metal and chlorine content than Sample 1 and Sample 2. The weight remain, % of Sample 3 was lower compared to Sample 1 and Sample 2. The decrease in weight remain, % after argon treatment (Sample 2) from 29.3 wt. % to 26.1 wt. % is primarily because of decrease in chlorine content (from 5.28 wt. % to 2.45 wt. %). The difference in weight remains, % for two-step chlorinated sample (Sample 3) and one-step chlorinated sample followed by argon treatment (Sample 2) is because of decrease in chlorine content. While only argon treatment (Sample 2) at 1050° C. for 4 hours decreased the chlorine content from ˜5.28 wt. % to 2.45 wt. %, it was not sufficient to decrease the chlorine content to values less than 1 wt. %.

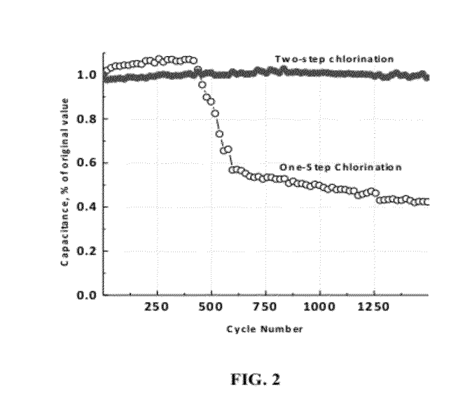

FIG. 2 shows electrochemical cyclability for two-step chlorination (solid markers) of Sample 3, as compared to one-step chlorination (open markers) of Sample 1. Electrochemical cells containing carbon synthesized using the one and two-step chlorination methods were cycled galvanostatically at 25 mA/cm² in 1.5 M tetratethylammonium tetrafluoroborate in acetonitrile. For the one-step chlorination (Sample 2), chlorination took place at 400° C. for 6 hours followed by argon purge at 1050° C. for four hours. For the two-step chlorination (Sample 3), chlorination took place at 400° C. for 6 hours, and then at 1050° C. for 2 hours. The furnace was heated in argon environment between first and second chlorination step. An argon purge of 4 hours at 1050° C. followed the second step chlorination. The higher cyclability i.e less capacitance change with number of cycles of Sample 3 is because of decrease in chlorine content and metal contents. Also, the capacitance of Sample 3 was higher capacitance than Sample 1 because of improved pore volume.

### Example 2

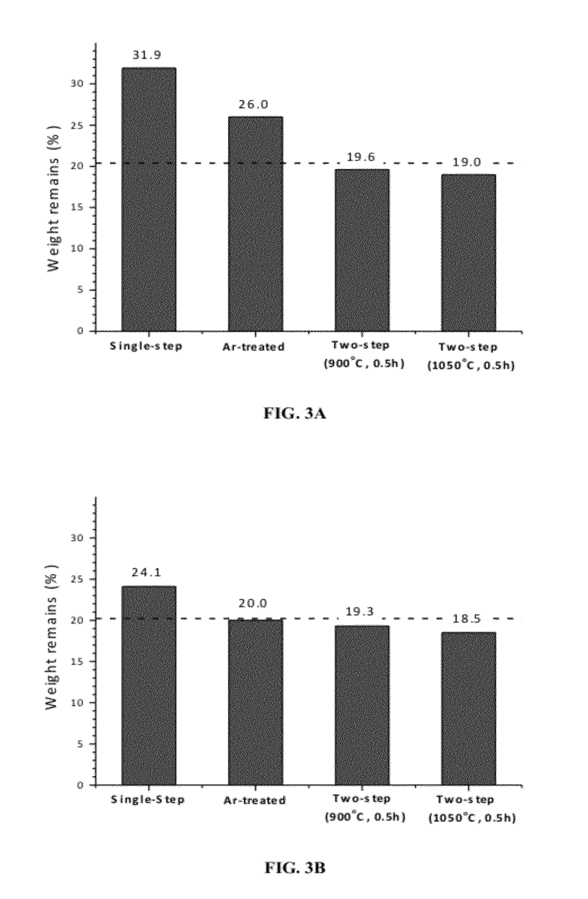

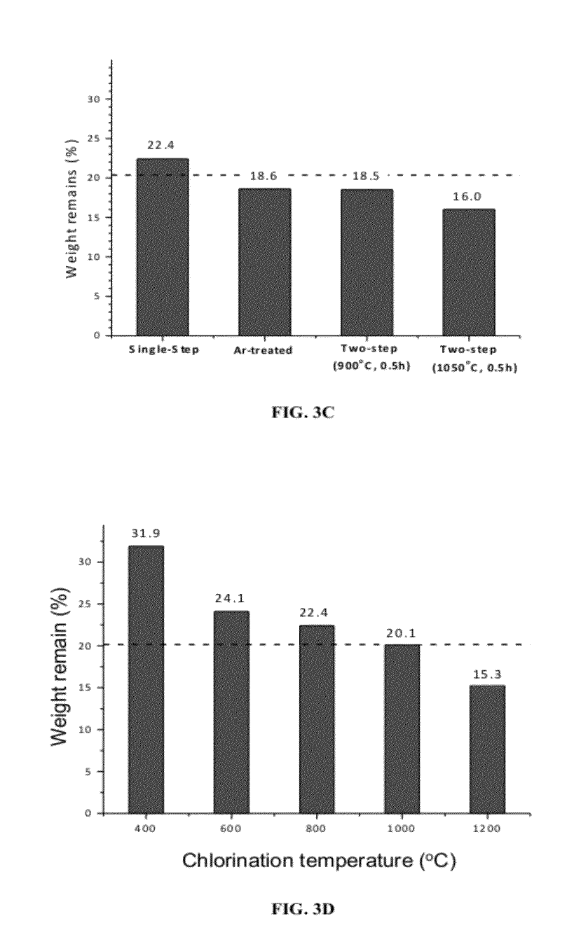

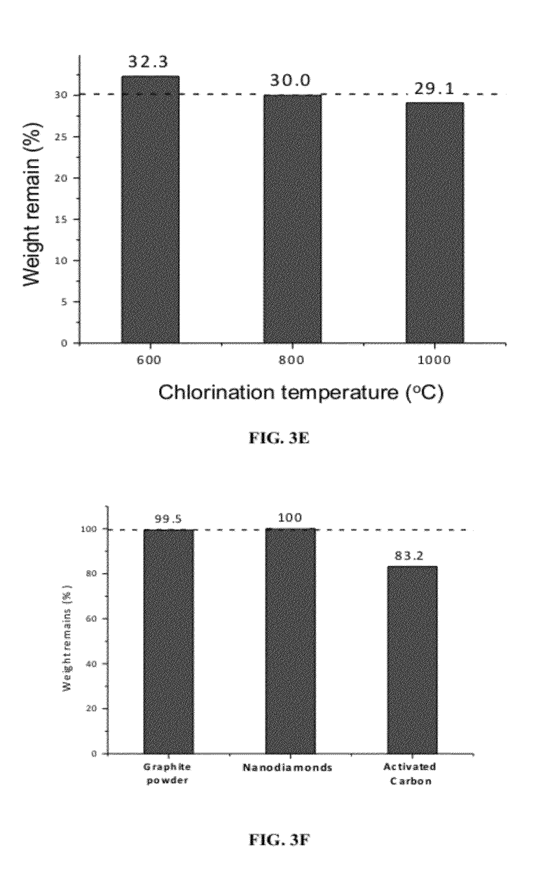

CDC powder was produced by chlorinating metal carbide powder precursor in a vessel at different chlorination. As can be seen in FIG. 3D and FIG. 3E, the weight remain, % decreases with chlorination temperature. Further, the weight remain, % for carbon made from titanium carbide was less than the theoretical value of 20.04% (FIG. 3C) for the conversion of titanium carbide to carbon suggesting that there is some degree of etching of carbon by chlorine. This clearly suggests that carbon is being etched by chlorine at temperatures above 800° C. contrary to the general belief that carbon is inert to chlorine. Thermodynamically, formation of CCl₄ (carbon tetrachloride) is feasible by chlorination of metal carbide but only at low chlorination temperatures (preferably below 600° C.). Graphite (vendor: Sigma-Aldrich, purity: 99.99%, particle size: <45 microns) is stable to chlorine and the chlorination at 1150° C. for 3.5 hours of pure graphite resulted in weight remain of 99.5% (FIG. 3F). Nanodiamond powder (grade: NB50) of 5 nm particle size was chlorinated at 1150° C. for 6 hours and no change in weight was noticed (FIG. 3F). The structure of nanodiamond is inherent to diamond and because of 5 nm particle size; it has relatively higher surface area. However, nanodiamond does not have internal pores and the surface area originates from the surface of the individual particles. Activated carbon (purity: >95%, particle size: <44 micron) was treated in chlorine at 1150° C. for 3.5 hours and a weight remain of 83.2% was noticed, consistent with etching of carbon by chlorine. No/minimal weight change in nanodiamond and graphite and weight change in amorphous activated carbon suggest that carbon structure plays an important role in enabling the etching of carbon by chlorine. As the CDC was found to etched with chlorine at high temperature and resulted in decrease in chlorine and metal content (FIG. 1), we decided to perform experiment whereby we perform a two step chlorination, first at lower temperature followed by relatively higher temperature. Thus, CDC material, which has can have a similar carbon structure to some activated carbons, can be further optimized by introducing additional chlorination steps to alter the porosity (caused by etching of carbon) and decrease the metal(s) and chlorine content. By adopting two-step chlorination, CDCs of pore sizes similar to lower temperature CDCs produced with single step chlorination but with higher purity can be obtained. To investigate the role of argon treatment, carbon produced by chlorination of titanium carbide at 400° C., 600° C. and 800° C. followed by argon treatment at the same temperature for 1 hour were investigated (FIGS. 3A, 3B, 3C). Argon treatment resulted in decrease in weight remain which can be explained by the decrease in chlorine level as mentioned in FIG. 1. The weight remain obtained from second step chlorination performed at 900° C. for 0.5 hour are shown in FIGS. 3A, 3B and 3C. As can be seen, the introduction of second-step chlorination decreased the weigh remain to level lowers than what is seen for single step chlorination further confirming our claim that second step chlorination resulted in etching of carbon. The weight remain was decreased further when a second chlorination at chlorination temperature of 1050° C. for 0.5 hour was employed (FIGS. 3A, 3B, 3C). Thus, increase in second chlorination step decreased the weight remain suggesting material with higher purity and alternate pore volumes can be produced with different second chlorination temperatures.

### Example 3

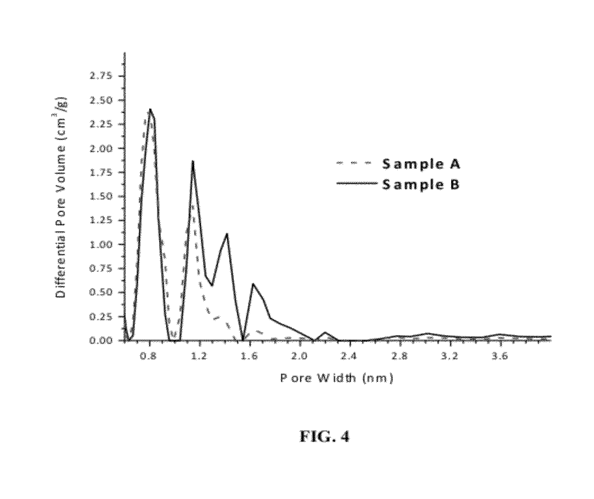

Two samples (Sample A and Sample B) (FIG. 4) were produced by chlorinating titanium carbide (TiC) powder precursor of particle size of <5 μm. Sample A was produced using single step chlorination temperature of 600° C. for 6 hours. Sample B was produced using two-step chlorination; the first chlorination was done at 600° C. followed by a second step chlorination at 1050° C. for 0.5 hour. The sample was not exposed to atmosphere between the first and second chlorination step. Argon was purged while increasing the temperature from 600° C. to 1050° C. A heating rate of 10° C./min was used. The purity of chlorine and argon are 99.999% and 99.999%, respectively. As can be seen in FIG. 4, the pore volume and surface area increased from 0.49 cm³/g to 0.54 cm³/g and 1125 m²/g to 1245 m²/g by using a two-step chlorination route. The surface area was calculated using Brunauer-Emmet-Teller. It is clear from this example that using two-step chlorination, one can further tailor the porosity (pore size, surface area, pore volume) of CDCs.

### REFERENCES CITED

Y. Gogotsi et al., Nature Materials, 2003
R. Dash, Ph.D. thesis, Drexel University, 2006
R. Dash et al., Carbon, 2006
R. K. Dash et al., Microporous and Mesoporous Materials, 2004
R. K. Dash et al., Microporous and Mesoporous Materials, 2005
J. Chmiola et al., Science, 2010
J. Chmiola et al., Science, 2006
Y. Gogotsi et al., J. Am. Chem. Soc., 2005
Y. Yushin et al., Biomaterials, 2006
C. Portet et al, Phys. Chem. Chem. Phys., 2009

### PATENTS OR APPLICATIONS

W. A. Mohun, Mineral Activated Carbon and Process for Producing Same, U.S. Pat. No. 3,066,099 (1962)
Y. Maletin et. al., Supercapacitor and Method of Making Such a Supercapacitor, U.S. Pat. No. 6,697,249 (2004)
R. Avarbz et. al., Process of Making a Porous Carbon Material and a Capacitor Having the Same, U.S. Pat. No. 5,876,787 (1999)
J. Leis, M. Arulepp, and A. Perkson, Method to Modify Pore Characteristics of Porous Carbon and Porous Carbon Materials Produced by the Method, US Patent Application US 2006/0140846
Y. Gogotsi and M. Barsoum, Nanoporous Carbide Derived Carbon with Tunable Pore Size, US Patent Application 2006/0165584
Y. Gogotsi, G. Yushin, E. Hoffman, E. Nola, and M. Barsoum, Process for Producing Nanoporous Carbide Derived Carbon with Large Specific Surface Area, US Patent Application 2009/0036302
Y. Gogotsi, J. Chmiola, G. Yushin, and R. Dash, Nanocellular High Surface Area Material and Methods for Use and Production Thereof, US Patent Application 2009/0213529
J. Leis, M. Arulepp, M. Latt, and H. Kuura, Method of Making the Porous Carbon Material of Different Pore Sizes and Porous Carbon Materials Produced by the Method, U.S. Pat. No. 7,803,345 (2010)

What is claimed is:

1. A method for manufacturing of porous carbon material produced by treating metal carbide with halogen at two or more halogenation temperatures in a stepwise manner such that the produced material consists of, essentially, by weight, less than 100 ppm of individual metal, less than 7,000 ppm of chlorine and greater than 99% of carbon. The first step can be any temperature between 100° C. to 800° C., the second and subsequent steps can be any temperature which is at least 50° C. higher than at the previous step. The time of halogenation can be between 1 to 10 hours and the second and subsequent halogenation can be between 1 minute to 3 hours.
The process described in claim 1 wherein the first step and the second and subsequent steps are performed with or without exposure of the material to the ambient atmosphere between the two steps.
The material produced by method described in claim 1 can be subsequently annealed under a purge of gases or under vacuum at elevated temperature.
The method of claim 1, where the gases used for annealing comprises of at least one of the following gases selected from the group consisting of argon, nitrogen, ammonia, and hydrogen.
The method of claim 1, wherein the temperature of halogenation is between 100° C. to 1600° C.
The method of claim 1, wherein the halogen comprises of at least one halogen selected from the group consisting of chlorine, fluorine, bromine, iodine, halides of chlorine, halides of fluorine, halides of bromine, halides of iodine.
The method of claim 1, wherein the metal carbide comprises at least one metal carbide selected from the group consisting of carbides, such as: carbides of Aluminum, Silicon, Chromium, Titanium, Zirconium, Boron, Tantalum, Niobium, Vanadium, Iron, Molybdenum, Tantalum, Tungsten and Calcium
The method of claim 1, wherein the surface area as calculated using Brunauer-Emmet-Teller (BET) method is greater than 5 m²/g and less than 3000 m²/g.
The method of claim 1, wherein the pore volume as calculated using density functional theory (DFT) theory is greater than 0.05 cm³/g and less than 2 cm³/g.
The method of claim 1, where the material can be used as electrode material in supercapacitor, battery, fuel cells, desalination and as adsorbent in gas sampling, breath analyzer, gas diffusion layer in fuel cell, hydrogen storage, methane storage, chlorine storage, and other gas storage.
The process described in claim 1, wherein the reactions take place in a fluidized bed reactor, rotary kiln, controlled atmosphere furnace, box furnace, tube furnace, or the like.
The material produced by the process described in claim 1, such that it may be used as a sorbent for gas and/or liquid filtration and/or separation, a sorbent for gas storage, or a sorbent for analytical techniques such as but not limited to gas chromatography and liquid chromatography, or a sorbent for use in medical applications such as but not limited to hemodiafiltration, enterosorbent, and toxin removal from biological fluids, or a sorbent for use in electrical energy storage applications such as but not limited to supercapacitor, battery and fuel cell.
